(19) United States
(12) Patent Application Publication
(10) Pub. No.: US 2008/0029173 A1
(43) Pub. Date: Feb. 7, 2008

(54) VARIABLE FLOW RESHAPABLE FLOW RESTRICTOR APPARATUS AND RELATED METHODS

(76) Inventor: Paul Mario DiPerna, San Clemente, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/694,841

(22) Filed: Mar. 30, 2007

Related U.S. Application Data
(63) Continuation-in-part of application No. 11/462,962, filed on Aug. 7, 2006.

(51) Int. Cl. F15C 1/00

(52) U.S. Cl. 137/803

(57) ABSTRACT

Disclosed in a novel apparatus and associated methods for controlling the flow around a reshapable flow restrictor. The flow restrictor reshapes as a function of the pressure differential within the flow restrictor. Small changes in the pressure differential allow for larger changes in the flow rate over conventional flow restrictor systems and provides for real time, fine-tuned adjustments to the flow rate.

### RELATED APPLICATIONS

This application claims the benefit of and priority of U.S. patent application Ser. Nos. 11/342,015, filed Jan. 27, 2006; Ser. No. 11/343,817, filed Jan. 31, 2006; and Ser. No. 11/462,962 filed Aug. 7, 2006; the contents of which are incorporated by reference herein in their entirety and are both subject to assignment to a common entity. Likewise, all Paris Convention rights are expressly preserved.

### BACKGROUND

This invention relates to an apparatus and associated methods for dispensing fluids or gasses at known, measurable rates. More specifically, the present invention relates to flow restrictors having reshapable lumina. The lumina reshapes as a function of pressure, which results in an increase in the flow rate by about a fourth order of magnitude.

### SUMMARY

Disclosed is a novel apparatus and associated methods for controlling the flow around a reshapable flow restrictor. The flow restrictor reshapes as a function of the pressure differential within the flow restrictor. Small changes in the pressure differential allow for larger changes in the flow rate over conventional flow restrictor systems and provides for real time, fine-tuned adjustments to the flow rate.

According to a feature of the present disclosure, an apparatus is disclosed comprising at least one reshapable flow restrictor having at least one lumen, a substantially rigid conduit to enclose the reshapable flow restrictor, a substance within the lumen of the reshapable flow restrictor to effect reshaping of the reshapable flow restrictor, and a deliverable material flowing within the rigid conduit. Accordingly, a flow rate of the deliverable material changes as a function of the cross-sectional diameter of the at least one reshapable flow restrictor.

Also according to a feature of the present disclosure, a method is disclosed comprising providing at least one reshapable flow restrictor enclosed in a substantially rigid conduit, wherein each flow restrictor reshapes as a function of the pressure within the reshapable flow restrictor and allowing for the pressure of a substance within each flow restrictor to vary, the variance in pressure causing each flow restrictor to reshape resulting in an increased or decreased flow rate of a deliverable material flowing in the rigid conduit. As pressure within each flow restrictor increases, the flow rate of the deliverable material decreases and as pressure within each flow restrictor decreases, the flow rate of the deliverable material increases.

Finally according to a feature of the present disclosure a method is disclosed comprising providing at least one reshapable flow restrictor disposed in a rigid conduit to vary the flow rate of a deliverable material flowing outside of each reshapable flow restrictor; wherein the flow rate of the deliverable material varies as a) a function of pressure within the rigid conduit and b) inversely as a function of the diameter of each reshapable flow restrictor; and wherein the diameter of each reshapable flow restrictor is changeable.

### DRAWINGS

The above-mentioned features and objects of the present disclosure will become more apparent with reference to the following description taken in conjunction with the accompanying drawings wherein like reference numerals denote like elements and in which:

FIG. 1 is an illustration of an embodiment of a flow restrictor system of the present disclosure;

FIG. 2 is a graph demonstrating the improved utility of the system taught in the present disclosure;

FIGS. 3A and 3B are illustrations of an embodiment of flow restrictors of the present disclosure with a circular lumina in both a resting state and a reshaped state;

FIGS. 4A and 4B are illustrations of an embodiment of flow restrictors of the present disclosure with a non-circular lumina in both a resting state and a reshaped state;

FIGS. 5A and 5B are illustrations of an embodiment of flow restrictors of the present disclosure with multiple lumina in both a resting state and a reshaped state;

FIGS. 6A and 6B are illustrations of an embodiment of flow restrictors of the present disclosure with a reshapable lumen;

FIG. 7 is an illustration of an embodiment of a flow restrictor of the present disclosure with a set of mechanical plates that reshape as the pressure of a flow material increases;

FIG. 8 is an illustration of an embodiment of a flow restrictor of the present disclosure using a mechanical feedback mechanism to increase the cross-sectional area of a lumen as the pressure of a flow material increases;

FIG. 9 is a graph demonstrating an embodiment of embodiments wherein a reshapable flow restrictor is disposed within a rigid conduit;

FIGS. 10A, 10B, and 10C are side views of an embodiment of a flow restrictor system of the present disclosure wherein the flow material flows on the outside of the restrictor and the restrictor is expanded by an expansion substance;

FIGS. 11A and 11B are perspective views of an embodiment of a flow restrictor system wherein a mechanical tool is used to expand or decrease the diameter of a flow restrictor disposed in a rigid conduit.

FIGS. 12A and 12B are side views of an embodiment of a flow restrictor system;

FIGS. 12A and 12B are cross-sectional views of an embodiment of the actual flow restrictor apparatus of the embodiments shown in FIGS. 12A and 12B;

FIG. 14 is a perspective diagram of an embodiment of the flow restrictor system of the present disclosure disposed in a gravity fed intravenous system;

FIGS. 15A and 15B are perspective views of an embodiment of a flow restrictor system having dual lumens disposed in a rigid conduit, wherein at least one lumen is dedicated to the flow of a flow material and at least one lumen restricts flow of the flow material by expanding or contracting as the pressure inside varies; and

FIGS. 16A and 16B are perspective views of an embodiment of a flow restrictor system having a flow restrictor disposed around the circumference of the lumen of a rigid conduit.

### DETAILED DESCRIPTION

For the purposes of the present disclosure, the term “reshape” or “reshapable” as applied to a flow restrictor shall be defined to include an increase or decrease in the cross-sectional area of the flow restrictor while retaining the same or a different overall shape.

The term “diameter” as used in the present disclosure shall mean the length of a straight line drawn from side to side through the center of the object for which the diameter is being measured.

The present inventors have discovered that by using pressure to vary not only the pressure differential, but also the diameter of a flow restrictor, large changes in flow rate may be effected by small changes in pressure. Moreover, by varying the shape of the flow restrictor, further fine tuning of the flow rate is effected.

Flow restrictors are common in many applications where regulation of the rate of flow is important. Flow restrictors allow for delivery of a gas or fluid at a controlled rate and may be predetermined or variable. Generally, the rate of flow may be calculated by the equation:

$$FlowRate ∼ \frac{Δ P μ {d}^{4}}{L}$$

where ΔP is the pressure differential at the ends of the flow restrictor, p is the viscosity of the flow material, d is the diameter of the flow restrictor lumen, and L is the length of the flow restrictor. The flow material may be gas, fluid, or combinations of the same, as is known to artisans.

When flow material flows through flow restrictor, the rate of flow is proportional to the viscosity of the fluid. As fluid viscosity increases, flow rate increases. In most systems, however, viscosity of the flow material is constant. Likewise, the length of the flow restrictor is constant. Length is measured from one end of the flow restrictor to the other end.

Prior to the teachings of the present disclosure, fixed diameter flow restrictors were used to provide a constant, pre-determined flow of flow material. A general problem associated with these flow restrictors was how to control the rate for flow through the restrictor. Prior to this disclosure, flow was controlled by controlling the pressure on either side of the flow restrictor. By increasing pressure in input reservoir, the rate of flow would increase because of the linear relationship between flow rate and pressure differential. Likewise, decreasing the pressure at the exit end of the flow restrictor tended to increase the pressure differential resulting in an increased flow rate.

In other conventional systems, users desired a variable flow rate. Naturally, the 1:1 proportionality of the pressure differential to the flow rate proved to be an effective means of variably controlling the rate of flow. Nevertheless, practical limitations prevented large changes in the flow rate. For example, if the desired flow rate was 50 times the original flow rate, the pressure would have to be increased 50 times, which necessitated building systems that could withstand large pressure swings. These types of systems were generally impractical in many circumstances due to cost, size, and material limitations, among other reasons. Instead, conventional systems typically used methods of slowing down flow rate to decrease the flow.

The present disclosure improves upon and addresses many of these issues by varying the diameter of the flow restrictor, measured a function of cross-sectional area of a flow restrictor lumen, in addition to pressure. Coupled with the use of a pump that can provide feedback on the volume of flow material delivered, the flow restrictor of the present disclosure provides a tool that can produce fine-tuned steady flow rates, in addition to a large range of flow rates.

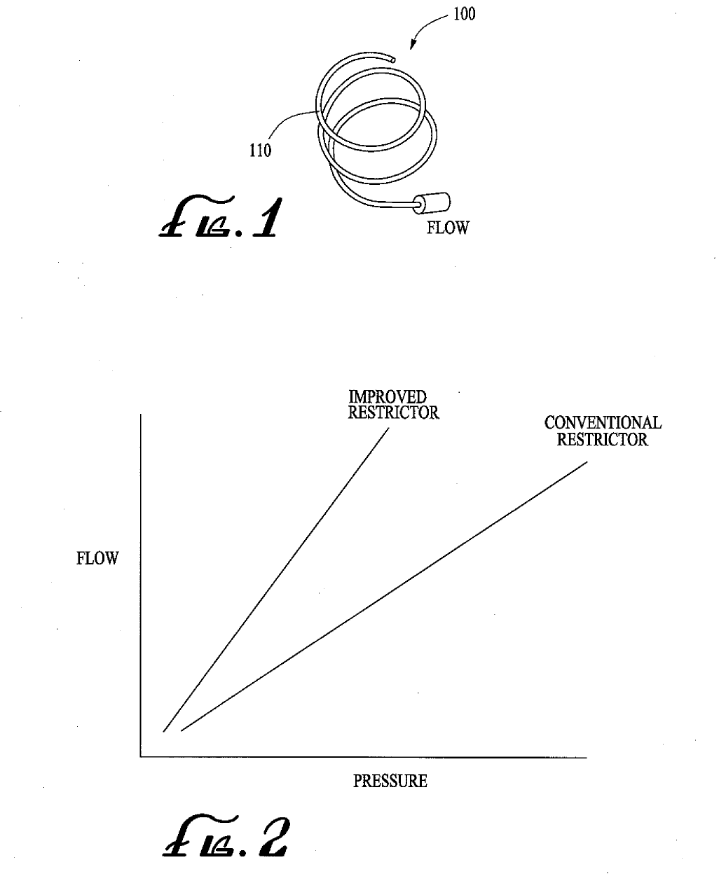

Turning now to an embodiment of the present disclosure demonstrated in FIG. 1, there is generally shown flow restrictor system 100. More specifically, flow restrictor system 100 comprises, in part, flow restrictor 110. Flow restrictor 110 may be any conventional flow restrictor, such as a capillary tube, designed to have flow restrictor lumen 120 vary as a function of pressure. As flow material flows through flow restrictor lumen 120, friction with flow restrictor lumen walls impede the free flow of the flow material, as is well understood by persons of ordinary skill in the art.

In the exemplary embodiment demonstrated in FIG. 1, flow restrictor 110 is made from soft, biocompatible compliant members, for example silicon rubber, natural rubber, polyisoprene, or urethane. Because these types of materials are soft, flow restrictor lumen 110 is reshapable. However, according to an embodiment, a plasticizer may be added to a flow restrictor 110 to soften harder materials to make the flow restrictor lumen more reshapable. Any plasticizer may be used provided the overall biocompatibility of the compliant member is retained, according to embodiments. It will be understood and appreciated by a person of ordinary skill in the art, however, that non-biocompatible materials may be used as well.

Referring again to an embodiment shown in FIG. 1 flow restrictor system 100 comprises a length of a flow restrictor 110, such as a length of tubing and connectors that allow flow restrictor system 100 to make suitable connections. Flow restrictor 110 comprises flow restrictor lumen 120. The inside cross-sectional area of flow restrictor lumen 120 may vary greatly depending on the application and is potentially useful in a variety of fields from nano-scale tubes to garden sprinklers and drip systems to oil field pumps, inter alia.

By using a soft material for flow restrictor 110 or by adding a plasticizer to flow restrictor 110, the cross-sectional area of flow restrictor lumen 120 becomes variable and may be reshapable. Thus, when coupled to a flow feedback mechanism, larger flow rates may be controlled by manipulating small pressure differentials. According to an embodiment, a suitable feedback mechanism is described in U.S. Pat. No. 7,008,403, which is hereby incorporated by reference in its entirety. The combination of using a feedback mechanism in conjunction with the teachings of the present disclosure allows for a much larger flow range and is more sensitive to tuning of flow rates in real time than those available in conventional flow restrictors.

FIG. 2 shows an embodiment of the utility of the present disclosure over conventional systems for controlling flow rate through flow restrictor 110. The illustrated graph shows flow rate as a function of pressure differential. The flatter the slope, that is, the closer the slope is to zero, the less sensitive flow rate is to changes in the pressure differential. Conversely, the steeper the slope, the more sensitive flow rate is to changes in the pressure differential. Steeper slopes have the advantage of delivering greater ranges of flow material.

As indicated, the present disclosure allows for flow rate to be manipulated over a smaller pressure differential range than in conventional flow restrictors. For example, to increase flow in a conventional flow restrictor requires a greater pressure differential because of its flatter slope. Conversely, improved flow restrictor system 100 taught herein causes an increase to the steepness of the slope shown in FIG. 2 (improved connector), allowing for a greater range of flow than in equivalent conventional flow restrictors. Moreover, by employing the use of a feedback mechanism to monitor flow rate, flow rate may be adjusted to achieve a desired flow rate.

Because the flow rate varies by order of magnitude of 4, small adjustments in pressure produce large changes in flow rate. Indeed, the steeper the slope of the flow rate versus pressure, the more pronounced the effect of small adjustments to pressure on the flow rate. Thus, use of a feedback mechanism allows for fine tuning of flow rate through minute adjustments in the pressure differential. Consequently, the present disclosure utilizes the greater range of flow rates without sacrificing the ability to have sensitive flow rate control.

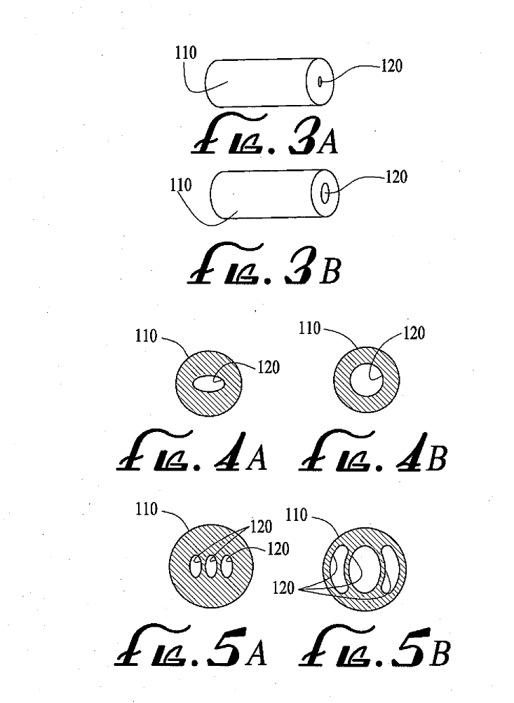

According to an embodiment demonstrated in FIGS. 3A and 3B, flow restrictor 110 comprises both a resting state and a reshaped state, as shown in FIG. 3A and FIG. 3B respectively. Increasing the pressure differential in flow restrictor lumen 120 causes its cross-sectional area to increase from its resting state, shown in FIG. 3A, to its reshaped state, as shown in FIG. 3B, where the cross-sectional area of flow restrictor lumen 120 is increased. The actual degree to which flow restrictor reshapes is a function of the pressure differential.

Similarly, reduction of the pressure differential causes flow restrictor lumen 120 in the reshaped state to return to the resting state shown in FIG. 3A. Indeed, changes to the pressure differential may be effected, which will tend to change the cross-sectional area of flow restrictor lumen 120. Flow rate will therefore be variable not only because flow rate is proportional to the pressure differential, but because the flow rate is proportional to the fourth root of the diameter (measured as a function of cross-sectional area) of flow restrictor lumen 120, the cross-sectional area of flow restrictor lumen 120 being determined by the pressure in flow restrictor lumen 120.

The present disclosure further discloses flow restrictors 110 with customizable improved slopes (see FIG. 2). FIG. 4A and FIG. 4B each respectively demonstrate an embodiment in a system wherein the slope of flow rate as a function of pressure differential may be further increased, giving additional ranges of flow rates as a function of pressure. By varying the shape of flow restrictor lumen 120, the slope of flow rate versus pressure differential may be fine tuned. In the embodiment disclosed in FIG. 4A, flow restrictor lumen 120 of FIG. 4A is oval, for example. Naturally, the flow rate through an oval lumen in a resting state differs from the flow rate through a circular lumen in the lumen's reshaped state due to the increase in the cross-sectional area in the circular lumen. As the pressure differential increases, flow restrictor lumen 120 reshapes, becoming more circular in the process. Thus, the slope of flow rate as a function of pressure differential is further modified as a result of lumen shape as compared to a circular lumen.

According to known, disclosed, and prototypical embodiments, flow restrictor lumens 120 may combine the effects of reshaping lumen 120 to increase the cross-sectional area of lumen 120 and expansion of lumen 120 to increase the cross-sectional area of lumen 120 to have more precise control over the flow rate.

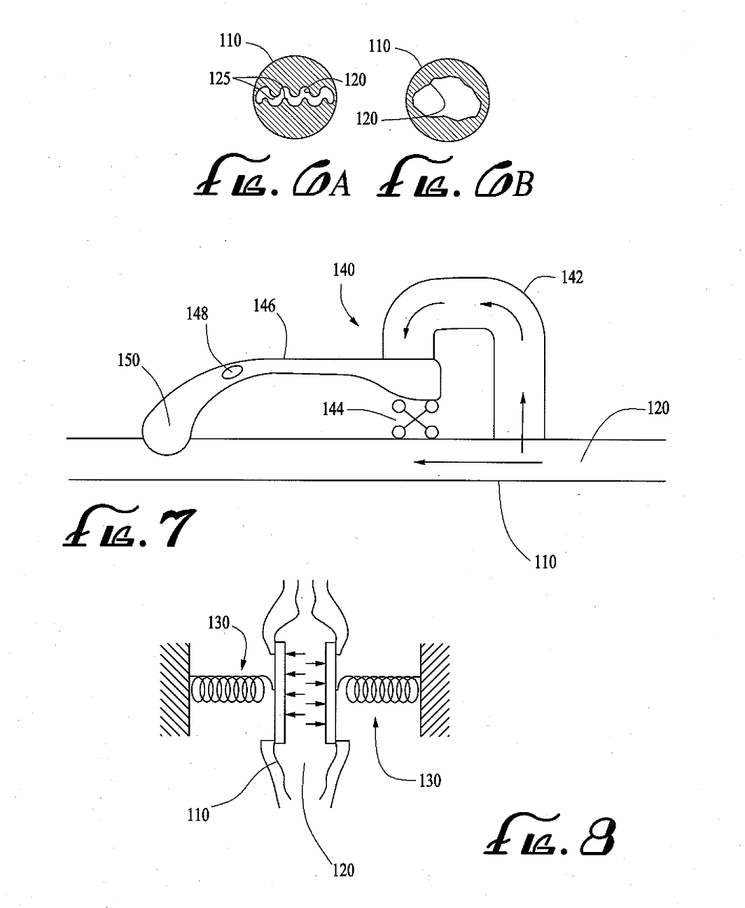

Similarly, FIG. 5A and FIG. 5B demonstrate other and further embodiments comprising multiple flow restrictor lumina 120. The embodiment shown in FIG. 5A shows flow restrictor 110 comprising multiple lumina 120 in a resting state. As the pressure differential is increased, flow restrictor lumina 120 reshape. The walls of lumina 120 are thin, which allows each lumen to expand in a reshaped confirmation without causing the outer diameter of the flow restrictor to increase. In its reshaped configuration, additional flow is effected due to reshaped cross-sectional area of lumina 120. Consequently, the slope of the flow rate as a function of pressure differential may be further manipulated as both a function of lumen number and lumen shape.

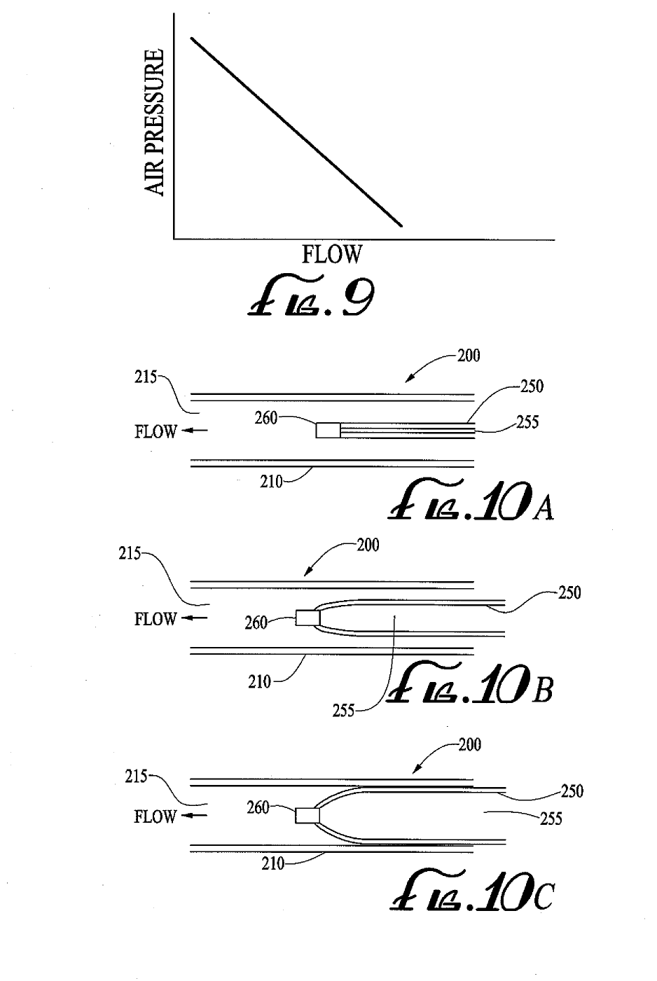

According to an embodiment shown in FIG. 6A and FIG. 6B, there is disclosed flow restrictor 110 comprising a fully reshapable flow restrictor lumen 120. In a resting confirmation, shown in FIG. 6A, flow restrictor lumen 120 comprises numerous lumen extensions 125. As the pressure of a flow material increases, the pressure forces the lumen extensions 125 to reshape into a configuration shown in FIG. 6B, thereby greatly increasing the flow as the cross-sectional area reshapes according to the principles disclosed previously. Lumen extensions 125 may be rugae or other extensions into lumen 120, or in some cases even non-smooth lumen walls.

An additional secondary feature contemplated by the present disclosure allows for further control of flow by increasing resistance to flow internally using lumen extensions 125 into lumen 120, similar to the embodiments shown in FIG. 6A and FIG. 6B. In addition to the benefit imparted by the variation in lumen diameter as previously described, lumen extensions 125, such as rugae in FIG. 6A and FIG. 6B, extend into lumen 120 and increase resistance due to increased boundary layer volume, which causes turbulent flow. As a flow material moves through lumen 120 in its unexpanded state, the increased surface area of lumen 120 creates a greater ratio of the flow material that constitutes a boundary layer. In other words, when lumen extensions 125 are introduced the ratio of the surface area to the cross-section of the flow material increases, which induces greater turbulent flow within the flow material fluid. As the turbulence within the flow material increases, the internal resistance of the flow material increases, reducing the flow rate.

As the pressure in lumen 120 increases, lumen extensions 125 reshape as shown in FIG. 6B. Once reshaped, the internal resistance decreases, which allows for increased flow rate. The net result of using lumen extensions 125 is a wider range of possible flow rates. A person of ordinary skill in the art will appreciate and understand that the variation in flow rate due to lumen extensions 125 in lumen 120 is only a small component to the variation of flow rates possible contemplated in the present disclosure. The majority of the flow rate variation is due to the change in diameter associated with the increase or decrease of pressure within lumen 120.

According to a related embodiment shown in FIG. 7, there is shown flow restrictor 110 with a mechanical mechanism for increasing the cross-sectional area of flow restrictor 110. According to the exemplary embodiment of FIG. 7, flow restrictor 110 comprises mechanical lever system 140. In addition to flow restrictor lumen 120, secondary flow restrictor lumen 142 branches off from flow restrictor lumen 120. Flow material flowing into secondary flow restrictor lumen 142 from flow restrictor lumen 130 is at substantially the same pressure as flow restrictor material in flow restrictor lumen 120. As shown in FIG. 7, however, secondary flow restrictor lumen 142 abuts with a proximal end of lever 146. Lever 146 prevents further flow of flow material. Nevertheless, the pressure of flow material is exerted on the proximal end of lever 146. Proximal end of lever 146 is positioned between secondary flow restrictor lumen 142 and mechanical lever system spring 144 to take advantage of the pressure exerted by flow material on the proximal end of lever 146.

Mechanical lever system spring 144 exerts force on lever 146 towards secondary flow restrictor lumen 142. Thus, the pressure exerted by a flow material and mechanical lever system spring 144 act opposite of each other, which determines the position of lever 146. Lever 146 pivots on mechanical lever system pivot 148, according to the exemplary embodiment. It will be understood by a person of ordinary skill in the art, however, the mechanical lever system pivot 148 is unnecessary to variations on the embodiment shown in FIG. 7.

The distal end of lever comprises resizer 150. In an embodiment, resizer 150 applies pressure to flow restrictor 110 downstream of the confluence between flow restrictor lumen 120 and secondary flow restrictor lumen 142. Mechanical lever system spring 144 applies pressure to the proximal end of lever 146, causing resizer 150 to apply pressure to flow restrictor 110. The effect of the pressure applied by resizer 150 to flow restrictor 110 reshapes flow restrictor lumen 120 with a smaller cross-sectional area, which reduces the flow rate of flow material. Conversely, pressure from flow material on lever 146 acts in opposition to mechanical lever system spring 144, causing resizer 150 to reduce pressure on flow restrictor 110, which effects a greater cross-sectional area of flow restrictor lumen 120.

Resizer 150 may apply pressure directly to flow restrictor 110 as shown in FIG. 7 or it may be integrated into flow restrictor lumen 120 as a physical impediment to flow. For example, resizer 150 may be integrated through the wall of flow restrictor 120. As pressure from mechanical lever system spring 144 is applied, resizer 150 pushes into flow restrictor lumen 120, causing a physical impediment to flow of flow material and reducing a cross-sectional area of flow restrictor lumen 120. Conversely, increased pressure of flow material counteracts the force of mechanical lever system spring 144, causing resizer 150 to withdraw from flow restrictor lumen 120, increasing the cross-sectional area of flow restrictor lumen 120.

FIG. 8 shows an embodiment that uses a mechanical system to effect an increase in the cross-sectional area of a flow restrictor as a function of pressure. According to the embodiment of FIG. 8, a flow restrictor may be made of non-reshapable materials, such as noncompliant metals and plastics, while providing the same functionality of the flow restrictors described in the present disclosure. Flow restrictor 110 comprises flow restrictor lumen 130 as other flow restrictor systems described previously in this disclosure. Because the flow restrictor of FIG. 8 is non-reshapable, flow restrictor lumen plates 125 are installed into flow restrictor 110 at the point where flow is to be restricted.

Flow restrictor lumen plates 125 connect to flow restrictor springs 130. Flow restrictor springs 130 maintain flow restrictor plates 125 in an unreshaped position. In the unreshaped configuration, flow restrictor plates 125 are in a configuration where the distance between each flow restrictor plate 125 is minimized or, in embodiments, the distance between flow restrictor plate 125 and a wall of lumen 120 is minimized. Consequently, the cross-sectional area of flow restrictor 110 is minimized when flow restrictor plates 125 are in an unreshaped configuration. When the pressure of a flow material increases, flow restrictor plates 125 assume a reshaped configuration. In the reshaped configuration, the pressure of the flow material compresses flow restrictor springs 130 due to the increased pressure exerted on flow restrictor plates 125, expanding the cross-sectional area of flow restrictor lumen 120 to effect greater flow rates as previously described.

Flow restrictor springs 130 are connected to a flow restrictor mount. Flow restrictor mount remains fixed with respect to flow restrictor system 100, such that when flow restrictor springs 130 compress, the flow restrictor mount remains fixed relative to the changed positions of flow restrictor springs 130 and flow restrictor plates 125. Thus, both flow restrictor plates 125 and flow restrictor springs 130 are moveable, but the flow restrictor mount is fixed with respect to flow restrictor plates 125 and flow restrictor springs 130. Thus, flow restrictor springs 130 return flow restrictor plates 125 to an unreshaped configuration when unpressured by a flow material.

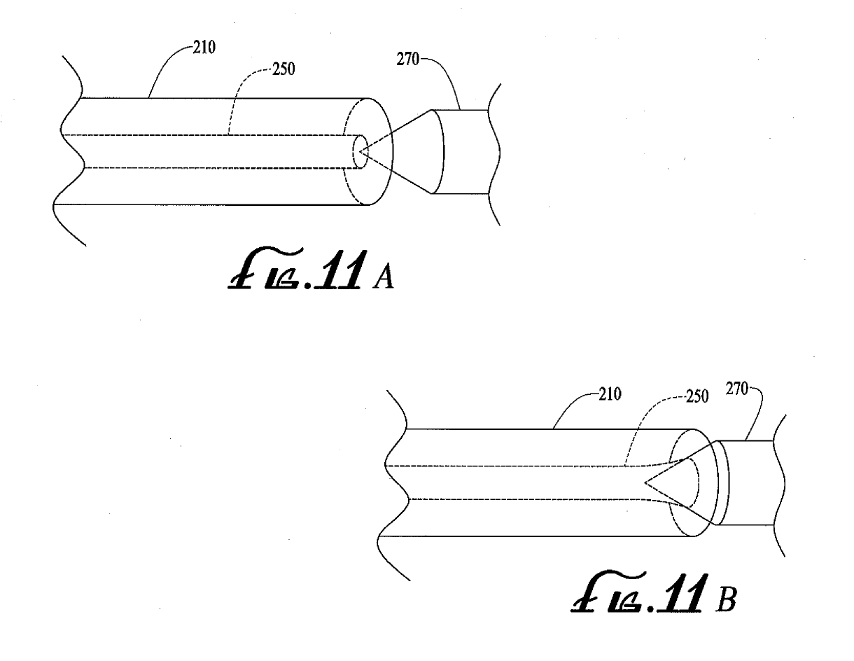

The principles of the present disclosure are also applicable to flow restrictor systems where the flow material flows outside of the flow restrictor in a rigid conduit. Within the flow restrictor, a second fluid or gas is dynamically pressurized or depressurized to expand or contract the diameter of a flow restrictor member and thus affect the flow rate of the fluid or gas to be delivered. According to these types of embodiments and as shown in FIG. 9, as pressure decreases, the flow rate of the flow material increases.

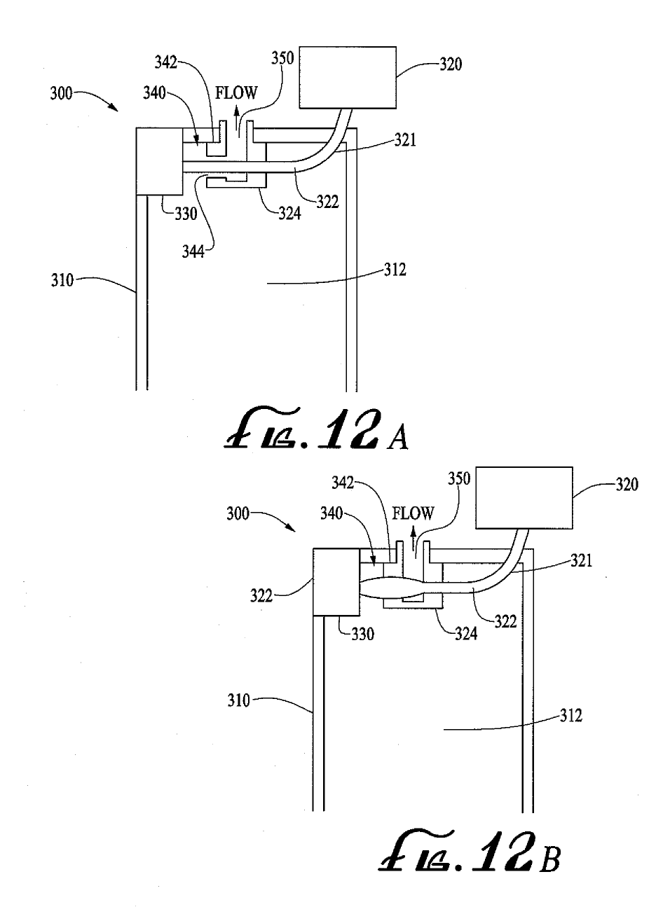

According to an embodiment and as shown in FIGS. 10A to 10C, flow restrictor system 200 is a flow restrictor wherein the flow material flows outside of variable diameter flow restrictor 260. Plow restrictor system 200 comprises delivery conduit 210 through which a flow material flows and flow restrictor 250 contained within delivery conduit 210. According to embodiments, delivery conduit 210 is rigid tubing or piping. Within delivery conduit 210, flow restrictor 250 impedes the flow volume of the flow material.

Flow restrictor 250 comprises flow restrictor lumen 255. Flow restrictor 250 is made from an expandable materials, according to embodiments, such as soft, biocompatible compliant members. For example silicon rubber, natural rubber, polyisoprene, or urethane, may be used to make flow restrictor 250, as disclosed herein. A fluid or gas that is not delivered is pumped into or removed from flow restrictor lumen 255 and used to expand or contract flow restrictor 250. At the end of flow restrictor lumen 255 is flow plug 260, which stops flow of the non-delivered gas or fluid and effects expansion of flow restrictor 255.

As shown in FIG. 10A to 10C, flow restrictor 250 may exist in a variable range of diameters effected by increasing the pressure of the non-delivered gas or fluid in flow restrictor lumen 255, which causes the diameter of flow restrictor 250 to increase, as shown in FIG. 10B. Eventually the pressure within flow restrictor lumen 255 reaches a level where flow restrictor 250 expands such that flow restrictor 250 occupies the entire diameter of delivery conduit lumen 215 by abutting against the rigid inner wall of delivery conduit lumen 215. Likewise, as the pressure of the non-delivered gas or fluid decreases within flow restrictor lumen 255, the diameter of flow restrictor 250 is reduced and increases the flow rate of the flow material through delivery conduit 250.

According to embodiments wherein the flow restrictor of the present disclosure is used with the infusion pumps incorporated by reference, two solenoids are used to pump the gas or fluid into flow restrictor 250 and remove the gas or fluid from flow restrictor 250.

According to embodiments and as shown in FIGS. 11A and 11B, the diameter of flow restrictor 250 may be increased within rigid conduit 210 using a mechanical tools 270, such as a tapered rod. As the mechanical tool 270 makes ingress into flow restrictor lumen along the length of flow restrictor 250, the diameter of flow restrictor 250 increases, restricting the flow around flow restrictor 250. As mechanical tool 270 is removed from flow restrictor lumen 255, the diameter of flow restrictor 250 decreases and exterior flow around flow restrictor 250 increases.

Ingress and egress of mechanical tool 270 may be accomplished, according to embodiments, using a shape change alloy such as Nitinol or the like. When the shape of the shape changing alloy changes, it applies pressure to a secondary mechanism that effects an increase or decrease in the diameter of flow restrictor 250. The shape changing alloy preferably provides for reversible shape changes; for example, the shape may be changeable according to the application of electrical current. According to an embodiment, a tapered rod is the secondary mechanism.

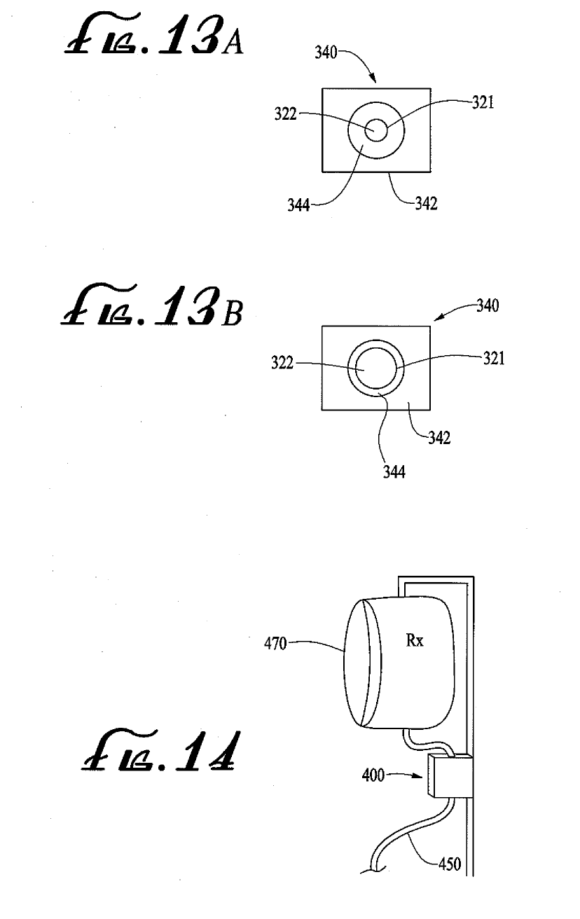

FIGS. 12A and 12B are demonstrative of an embodiment of flow restrictor system 300 wherein the fluid to be delivered flows outside of an adjustable flow restrictor. According to embodiments, flow restrictor system 300 is built into fluid vessel 310. The flow material is contained in fluid reservoir 312 of fluid vessel 310. At a delivery end of fluid reservoir 312, components that variably restrict the flow of fluid are disposed, including flow restrictor 321, restriction block 324, flow block seam 330, restriction block 342, and restrictor flow channel 344. After the flow material passes through the flow restriction area (indicated generally by 340), the flow material flows through flow lumen 350 and outside of flow restrictor system 300.

Fluid vessel 310 is a intravenous (IV)-type bag, according to embodiments. Fluid vessel 310 is adapted specifically to be used as flow restrictor system 300. Accordingly, restrictor flow lumen 350 is adapted to be connected by external components as known in the art. Additionally, fluid vessel 310 comprises a second opening through which flow restrictor 321 connects to pump mechanism 320. Pump mechanism 320 causes the pressure of a non-delivered fluid or gas in flow restrictor lumen 322 to increase or decrease. Pump mechanism 320, according to embodiments, may work in conjunction with a feedback mechanism to dynamically adjust the flow rate from the fluid vessel 310 according to a predetermined set of criteria.

The flow rate of a flow material from fluid reservoir 312 into flow lumen 350 is controlled in flow restriction area 340. Flow restriction area 340 comprises flow restrictor 321, restriction blocks 324, 342 and restrictor flow channel 344. Restrictor flow channel 344 is the conduit wherein fluid vessel 310 and flow lumen 350 are in fluid communication. Restrictor flow channel 344 is defined by restriction blocks 324 and 342, which may be welds in an IV bag, for example. Restriction blocks 324, 342 are made from the same material from which fluid vessel 310 and comprise seams that prevent fluid from flowing through. Thus, they form the boundaries of a channel between fluid reservoir 312 and flow lumen 350.

Flow restrictor 321 is disposed inside of flow restrictor channel 344. Flow restrictor 321 is connected to pump mechanism 320 via flow restrictor lumen 322. Flow restrictor 321 is bounded at the end opposite of the connection to pump mechanism 320 by flow blocker 330, which is a sealed portion of fluid vessel 310. Flow blocker 330 blocks fluid or gas flow within flow restrictor lumen 322 to cause flow restrictor to expand as pump mechanism 320 increases the pressure of the fluid or gas within flow restrictor lumen 322. According to embodiments, flow blocker 330 is structurally weaker than flow restrictor 321. Thus, flow blocker 330 is predisposed to rupture before flow restrictor 321 ruptures, preventing the fluid or gas within flow restrictor lumen 322 to be expelled into flow restrictor system 300 and preventing the chance for gas or impurities to enter the IV line, for example.

According to embodiments, flow material via flow lumen 350 flows from fluid reservoir 312 into flow restriction area 340. FIG. 12A shows a cross-sectional view of the embodiment shown in FIG. 12A, wherein flow restriction area 340 comprises flow restrictor 321 and restrictor flow channel 344. Fluid in fluid reservoir 312 flows through restrictor flow channel 344 into flow lumen 350. As the fluid or gas in flow restrictor lumen 322 increases in pressure as it is pumped from pump mechanism 320, flow restrictor 321 expands, as shown in FIGS. 12B and 12B. As flow restrictor 321 expands, the area of restrictor flow channel 344 is reduced, thereby reducing the volume of flow material flowing through restrictor flow channel 344 into flow lumen 350. Similarly, as fluid or gas is removed from flow restrictor lumen 322, the diameter of restrictor flow channel 344 increases and the volume of flow material flowing into flow lumen 350 is increased.

According to an embodiment as shown in FIG. 13, the flow restrictor systems of the present disclosure are used in conjunction with gravity fed IV bags. According to other embodiments, infusion pumps, such as those incorporated by reference, and other infuser technologies move fluid through a flow restrictor system, as known in the art. Use of the flow restrictor systems taught herein provides a dynamic range of rates in which a fluid or gas may be delivered. According to embodiments, the flow restrictor system is built into IV bags, as shown in FIGS. 12A, 12B, and 14.

Alternatively, according to embodiments and as shown in FIG. 14, flow restrictor system 400 may be disposed between IV bag 470. Flow conduit 450 ensures that all of the IV bag 470, flow restrictor system 400, and a patient are in fluid communication such that the fluid in the IV bag 470 is delivered into the body of the patent, as is well known in the art. It will be appreciated by a person of ordinary skill in the art that the FIG. 14 merely illustrates the application of the present disclosure to both pumped flow materials and flow materials that flow by other mechanisms.

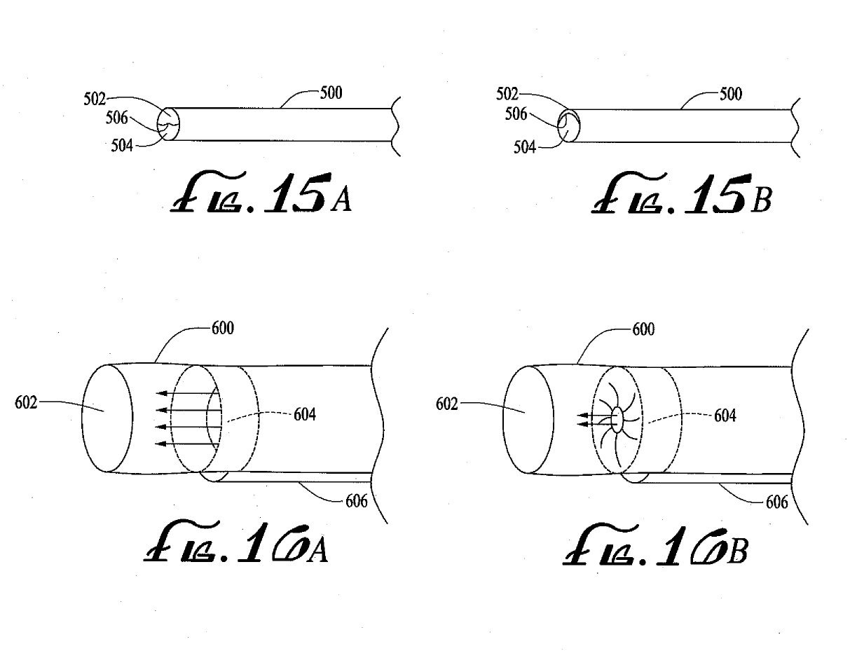

According to an embodiment as shown in FIGS. 15A and 15B, a multiple lumen rigid conduit 500 provides both flow restrictor 504 and delivery conduit 502 separated by flexible septum 506. A flow material travels through delivery conduit 502. Likewise a non-deliverable fluid or gas is contained within flow restrictor 504, which is blocked at an end and connected to a pump mechanism at the other end, according to embodiments. When flow needs to be restricted, the pump mechanism increases pressure in flow restrictor 504 effecting an increase in the cross-sectional area of flow restrictor 504 as flexible septum 506 distends with the increasing pressure. As the cross-sectional area of flow restrictor 504 increases, the cross-sectional area of delivery conduit 502 decreases because the multiple lumen conduit 500 is rigid and will not expand with increasing pressure.

Similarly and according to an embodiment shown in FIGS. 16A and 16B, rigid conduit 600 may have one or more expandable flow restrictors 604 incorporated into rigid conduit lumen 602. Each expandable flow restrictor 604 may be made from a biocompatible or non-biocompatible material that will expand. As shown in FIG. 16A, flow restrictor 604 is disposed within rigid conduit lumen 602 around the circumference of the wall of rigid conduit lumen 602. Flow restrictor 604 is in fluid communication with flow restrictor conduit 606. Flow restrictor conduit provides a path whereby the pressure within flow restrictor 604 is increased. According to an embodiment, flow restrictor conduit 606 is connected to a pumping mechanism whereby the pressure in flow restrictor 604 is increased or decreased. Neither flow restrictor 604 nor flow restrictor conduit 606 are in fluid communication with rigid conduit lumen 602.

According to embodiments, multiple flow restrictors 604 may be incorporated into a rigid conduit 600. Each flow restrictor 604 is a flexible material of varying elasticity, all of which are connected to one flow restrictor conduit 606. As pressure of a non-deliverable fluid or gas is increased in flow restrictor conduit 606 and consequently in flow restrictor 604, each individual flow restrictor will be expanded to a varying volume as a function of the elasticity of each flow restrictor 604. Thus, within a single rigid conduit, multiple flow restrictors 604 are disposed in a manner that induces turbulent flow and provides a mechanism to further restrict the flow rate.

The present disclosure also discloses methods for using flow restrictor system. Flow restrictor system is connected to a feedback mechanism as would be understood by a person of ordinary skill in the art. Once connected, a flow material is added to the system containing flow restrictor system. As the flow material flows through flow restrictor, the pressure differential determines flow rate in the resting state of flow restrictor. As the pressure differential increases by increasing the pressure in the fluid prior to its entering flow restrictor or by decreasing pressure on the end of flow restrictor, flow restrictor lumen reshapes causing a further increase in flow rate, in addition to the increase in flow rate directly caused by the increased pressure. The ways in which pressure is manipulated on either side of flow restrictor would be well understood by a person of ordinary skill in the art.

By using the connected feedback mechanism, flow may be controlled with precision. As modifications in the pressure are effected, the flow rate varies. Because flow varies with slight changes in pressure differential, the feedback mechanism is used to adjust flow rate to the desired level. Moreover, the closer the slope of the flow rate as a function of pressure differential is to being undefined (i.e., approaching a vertical slope), the more sensitive the flow rate is to slight changes in pressure differential. Thus, providing a feedback mechanism provides a method for controlling flow with steep sloped flow restrictors, where small pressure adjustments cause large flow rate changes.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. An apparatus comprising:
at least one reshapable flow restrictor having at least one lumen;
a substantially rigid conduit to enclose the reshapable flow restrictor;
a substance within the lumen of the reshapable flow restrictor to effect reshaping of the reshapable flow restrictor; and
a deliverable material flowing within the rigid conduit.

2. The apparatus of claim 1, wherein a flow rate of the deliverable material changes as a function of the cross-sectional diameter of the at least one reshapable flow restrictor.

3. The apparatus of claim 2, wherein each reshapable flow restrictor is capable of increasing in cross-sectional area to occupy substantially the entire cross-section of the rigid conduit, thereby substantially preventing the flow of the deliverable material through the rigid conduit.

4. The apparatus of claim 2, wherein the reshapable flow restrictor is made from a compliant biocompatible material.

5. The apparatus of claim 4, wherein the compliant biocompatible material is at least one of the group consisting of silicon rubber, natural rubber, polyisoprene, and urethane.

6. The apparatus of claim 2, wherein the reshapable flow restrictor is used in the drilling and transport of petroleum products.

7. The apparatus of claim 2, wherein the reshapable flow restrictor is a non-circular shape.

8. The apparatus of claim 2, further comprising a feedback measuring device to measure at least the flow rate of the deliverable material.

9. The apparatus of claim 8, wherein the feedback measuring device provides at least flow rate data in about real time.

10. A method comprising:
providing at least one reshapable flow restrictor enclosed in a substantially rigid conduit, wherein each flow restrictor reshapes as a function of the pressure within the reshapable flow restrictor; and
allowing for the pressure of a substance within each flow restrictor to vary, the variance in pressure causing each flow restrictor to reshape resulting in an increased or decreased flow rate of a deliverable material flowing in the rigid conduit;
wherein as pressure within each flow restrictor increases, the flow rate of the deliverable material decreases and as pressure within each flow restrictor decreases, the flow rate of the deliverable material increases.

11. The method of claim 10, wherein the reshapable flow restrictor is made from a compliant biocompatible material.

12. The method of claim 10, wherein the reshapable flow restrictor is used in the drilling and transport of petroleum products.

13. The method of claim 10, further comprising providing a feedback measuring device to monitor a flow rate in about real time.

14. The method of claim 13, wherein adjustments to the flow rate of the deliverable material are calculated using data derived from the feedback measuring device.

15. The method of claim 14, wherein adjustments to the flow rate of the deliverable material are effected using data derived from the feedback measuring device.

16. The method of claim 10, wherein the resultant shape of each flow restrictor after a change in pressure comprises a larger or smaller cross-sectional area.

17. A method comprising:
providing at least one reshapable flow restrictor disposed in a rigid conduit to vary the flow rate of a deliverable material flowing outside of each reshapable flow restrictor;
wherein the flow rate of the deliverable material varies as a) a function of pressure within the rigid conduit and b) inversely as a function of the diameter of each reshapable flow restrictor; and
wherein the diameter of each reshapable flow restrictor is changeable.

18. The method of claim 17, wherein the diameter of each reshapable flow restrictor changes as the pressure of a substance in each reshapable flow restrictor changes.

19. The method of claim 18, wherein the flow rate of the deliverable material is monitored by a feedback measuring device; and
wherein the feedback measuring device measures at least the flow rate of the deliverable material.

20. The method of claim 19, wherein the feedback measuring device measures at least the flow rate of the deliverable material in about real time.
